(19) United States
(12) Patent Application Publication
(10) Pub. No.: US 2016/0332338 A1
(43) Pub. Date: Nov. 17, 2016

(54) Release Device Applied in Electronic Package

(71) Applicant: SureGiant Technology Co., Ltd, Luzhu/Taoyuan (TW)

(72) Inventor: Yun-Pin Yang, Luzhu/Taoyuan (TW)

(21) Appl. No.: 15/221,895

(22) Filed: Jul. 28, 2016

Related U.S. Application Data
(63) Continuation-in-part of application No. 14/010,521, filed on Aug. 27, 2013.

(51) Int. Cl. B29C 33/68; B32B 27/30; B32B 27/14; B32B 27/32; B32B 9/04; B32B 27/36; B32B 27/28

(52) U.S. Cl. CPC B29C 33/68; B32B 27/36; B32B 27/304; B32B 27/281; B32B 27/32; B32B 27/365; B32B 9/045; B32B 27/14; B32B 2307/536; B32B 2250/02; B32B 2264/102; B32B 2307/748; B29K 2901/12; B29K 2995/0097; B29K 2995/007

(57) ABSTRACT

The present invention relates to a release sheet applied in electronic packaging, wherein the release device is attached to the inner surface of a transfer modeling mold for electronic packaging. In the present invention, the release device consists of a substrate and a release layer formed on the substrate, wherein the substrate is made of a plastic material with the thickness of 0.016-0.1 mm, and the plastic material can be PET, PP, PC, PE, PI, or PVC. Differing from the substrate, the release layer is constituted by a silica gel, a rubber, an antistatic material, and a plastic material and has the thickness of 0.02-2 mm The release sheet can provide a releasing force for facilitating the modeled device formed by using the transfer modeling mold be easily separated from the mold, and avoid part of manufacture material from remaining in the inner surface of the mold.

### CROSS-REFERENCE TO RELATED APPLICATIONS

This application is a continuation-in-part of co-pending U.S. patent application Ser. No. 14/010,521 filed on Aug. 27, 2013. The above referenced application, and each document cited or referenced in the above referenced application, are hereby incorporated herein by reference.

### BACKGROUND OF THE INVENTION

1. Field of the Invention

The present invention relates to transfer modeling technologies for electronic packaging, and more particularly to a release sheet applied in electronic packaging.

2. Description of the Prior Art

Currently, the primary process of thermosetting plastic is compression molding. When a compression molding process is executed, because the thermosetting plastic must be cooled for solidification, the modeled thermosetting plastic does usually be separated from the mold after the solidification is completed; for this reason, the production efficiency of the compression molding process is hard to be increased. Accordingly, a transfer modeling technology is proposed. Please refer to FIG. 1, there is shown a schematic diagram for the manufacturing process of the transfer modeling technology; as shown in FIG. 1, the manufacturing process of the transfer modeling technology includes the processing steps of:
(1) disposing a molding plastic material 11′ in a transfer modeling chamber 15′;
(2) putting a device to be modeled in a mold 14′, wherein the mold 14′ connects with the transfer modeling chamber 15′ via an injection channel 16′;
(3) heating the molding plastic material 11′ for liquefying the molding plastic material 11′ in the transfer modeling chamber 15′;
(4) filling a fluid plastic material 13′ into the heated mold 14′ through the injection channel 16′;
(5) cooling the mold 14′ for making the fluid plastic material 13′ solidify;
(6) opening the mold 14′, and separating the modeled device 60′ from the mold 14′;
(7) taking out the modeled device 60′;
(8) there are some solidified plastic material remaining in the transfer modeling chamber 15′ and the injection channel 16′, and these remained plastic material needs to be remove before the second manufacturing process of the transfer modeling technology is executed.

Usually, it needs to attach a release sheet onto the inner surface of the mold 14′ for facilitating the modeled device 60′ be easily separated from the mold 14′ in processing step (7). Accordingly, the inventor of the present application has made great efforts to make inventive research thereon and eventually provided release sheet applied in electronic packaging.

### SUMMARY OF THE INVENTION

The primary objective of the present invention is to provide a release sheet applied in electronic packaging, used for being attached to the inner surfaces of a transfer modeling mold when a transfer modeling electronic packaging is processed. The release sheet of the present invention can provide a releasing force for facilitating the modeled device formed by using the transfer modeling mold be easily separated from the mold, and avoid part of manufacture material from remaining in the inner surface of the mold.

Accordingly, to achieve the primary objective of the present invention, the inventors propose an embodiment for the release sheet applied in electronic packaging, which is used for being attached to the inner surface of a transfer modeling mold for electronic packaging, and comprises:
a substrate, having a substrate thickness ranged from 16 μm to 100 μm; wherein the substrate is made of a plastic material selected from the group consisting of: polyethylene terephthalate (PET), polypropylene (PP), polycarbonate (PC), polyethylene (PE), polyimide (PI), and polyvinylchloride (PVC);
a release layer, being formed on the substrate with a release layer thickness ranged from 20 μm to 2000 μm, wherein the release layer is made of a silica gel, a rubber, an antistatic material, and a plastic material;
wherein the mass percent of the silica gel in the release layer is in a first range from 80% to 50%, the mass percent of the rubber in the release layer being in a second range from 10% to 40%, the mass percent of the antistatic material in the release layer being in a third range from 0% to 5%, and the mass percent of the plastic material in the release layer being in a fourth range from 0% to 5%.

For the embodiment of the release sheet applied in electronic packaging, wherein the hardness of the release sheet is ranged from 10 to 80 according to the standard SHORE type A of ASTMD2240.

### BRIEF DESCRIPTION OF THE DRAWINGS

The invention as well as a preferred mode of use and advantages thereof will be best understood by referring to the following detailed description of an illustrative embodiment in conjunction with the accompanying drawings, wherein:

FIG. 1 shows a schematic diagram for the manufacturing process of the transfer modeling technology;

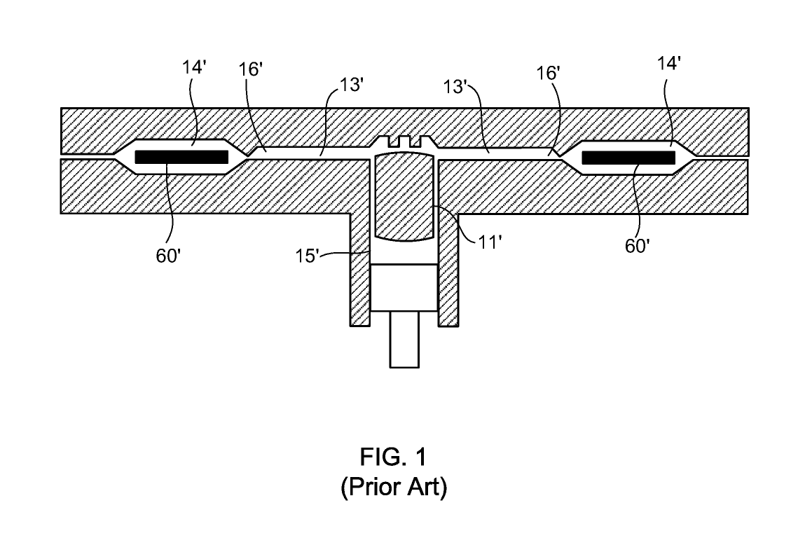

FIG. 2 shows a schematic diagram for the manufacturing process of transfer modeling electronic packaging;

FIG. 3 shows a side cross-sectional view of a release sheet applied in electronic packaging according to the present invention.

### DETAILED DESCRIPTION OF THE PREFERRED EMBODIMENTS

To more clearly describe a release sheet applied in electronic packaging according to the present invention, embodiments of the present invention will be described in detail with reference to the attached drawings hereinafter.

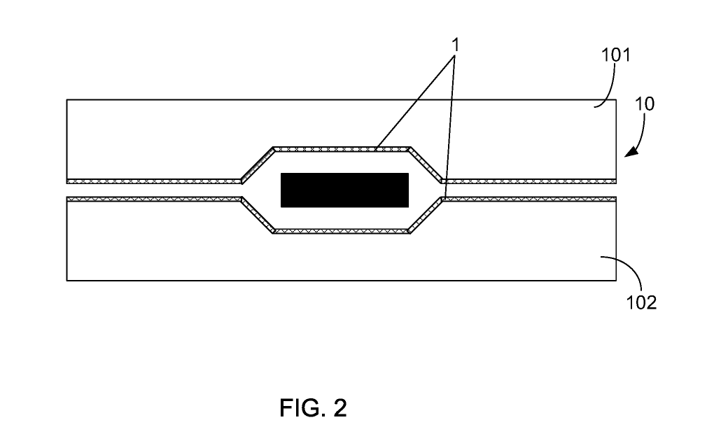

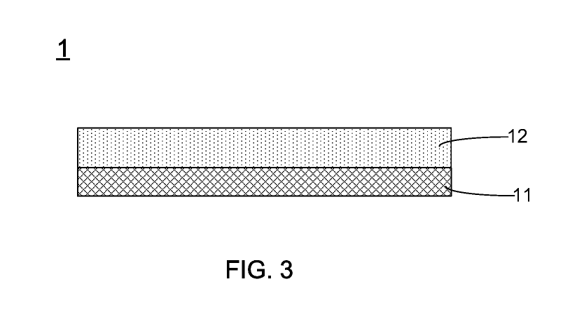

Please refer to FIG. 2, which illustrates a schematic diagram for the manufacturing process of transfer modeling electronic packaging; moreover, please simultaneously refer to FIG. 3, there is shown a side cross-sectional view of a release sheet applied in electronic packaging according to the present invention. As shown in

FIG. 2 and FIG. 3, the release sheet e 1 of the present invention is used for being attached to the inner surfaces of an upper mold 101 and a lower mold 102 of a transfer modeling mold 10 when the transfer modeling electronic packaging is processed, wherein the release sheet 1 mainly consists of a substrate 11 and a release layer 12 formed on the substrate 11.

In the present invention, the manufacture material of the substrate 11 can be polyethylene terephthalate (PET), polypropylene (PP), polycarbonate (PC), polyethylene (PE), polyimide (PI), or polyvinylchloride (PVC), and the thickness of the substrate 11 is in a range from 16 μm to 100 μm. Differing from the substrate 11, the thickness of the release layer is in a range from 20 μm to 2000 μm.

In order to obtain a release sheet 1 possessing a particular hardness ranged from 1 to 80 according to the standard SHORE type A of ASTMD2240, the release layer 12 is constituted by a plurality of specific materials, including: a silica gel, a rubber, an antistatic material, and a plastic material. In the release layer 12, the mass percent of the silica gel in the release layer is in a first range from 80% to 50%, the mass percent of the rubber in the release layer is in a second range from 10% to 40%, the mass percent of the antistatic material in the release layer is in a third range from 0% to 5%, and the mass percent of the plastic material in the release layer is in a fourth range from 0% to 5%.

It needs to further explain that, the antistatic material is selected from the group consisting of: conductive carbon black, amine-group compound, phosphate compound, ethoxylated glycol esters of fatty acid, and fatty amine compound. Thus, above descriptions have introduced the constituting materials of the release sheet 1 proposed by the present invention; in follows, the practicability of the release sheet 1 will be proved by showing a variety of experimental data. Please refer to following Table 1, where a variety of measured hardness data of the release sheet 1 are integrated. From Table 1, it can find that the hardness of the release sheet 1 can be modulated by way of adjusting the mass percent of silica gel and rubber as well as fixing the antistatic material and the plastic materials' mass percent. So that, it is clear that the present invention provides a release sheet 1 constituted by the silica gel, the rubber, the antistatic material and the plastic material, wherein the hardness of the release sheet 1 can be easily modulated or adjusted in order to meet the requirements demanded by different electronic packaging applications.

TABLE 1

| | | mass | mass | hardness of |
|---|---|---|---|---|
| | mass | percent | percent | the release sheet |
| mass percent | percent | of | of | measured according to the |
| of | of | antistatic | plastic | standard SHORE type A |
| silica gel | rubber | material | material | (ASTMD2240) |
| 90 wt % | 5 wt % | 3 wt % | 2 wt % | 15~28 |
| | | | | (Type I release sheet) |
| 70 wt % | 25 wt % | 3 wt % | 2 wt % | 24~45 |
| | | | | (Type II release sheet) |
| 45 wt % | 50 wt % | 3 wt % | 2 wt % | 33~56 |
| | | | | (Type III release sheet) |
| 30 wt % | 65 wt % | 3 wt % | 2 wt % | 42~78 |
| | | | | (Type IV release sheet) |

Thus, the above descriptions have been completely introduced the release sheet 1 applied in electronic packaging according to the present invention; in summary, the release sheet 1 of the present invention includes the advantages of follows:

(1) The release sheet 1 can be attached to the inner surfaces of the transfer modeling mold 10 when the transfer modeling electronic packaging is processed, so as to provide a releasing force for facilitating the modeled device formed by using the transfer modeling mold 10 be easily separated from the mold, and simultaneously avoid part of manufacture materials from remaining in the inner surface of the transfer modeling mold 10.

The above description is made on embodiments of the present invention. However, the embodiments are not intended to limit scope of the present invention, and all equivalent implementations or alterations within the spirit of the present invention still fall within the scope of the present invention.

What is claimed is:

1. A release sheet applied in applied in electronic packaging, used for being attached to the inner surface of a transfer modeling mold for applied in electronic packaging, wherein the release sheet comprises:
a substrate, having a substrate thickness ranged from 16 μm to 100 μm; wherein the substrate is made of a plastic material selected from the group consisting of:
polyethylene terephthalate (PET), polypropylene (PP), polycarbonate (PC), polyethylene (PE), polyimide (PI), and polyvinylchloride (PVC);
a release layer, being formed on the substrate with a release layer thickness ranged from 20 μm to 2000 μm, wherein the release layer is made of a silica gel, a rubber, an antistatic material, and a plastic material;
wherein the mass percent of the silica gel in the release layer is in a first range from 80% to 50%, the mass percent of the rubber in the release layer being in a second range from 10% to 40%, the mass percent of the antistatic material in the release layer being in a third range from 0% to 5%, and the mass percent of the plastic material in the release layer being in a fourth range from 0% to 5%.

2. The release sheet applied in applied in electronic packaging of claim 1, wherein the hardness of the release sheet is ranged from 10 to 80 according to the standard SHORE type A of ASTMD2240.

3. The release sheet applied in applied in electronic packaging of claim 1, wherein the antistatic material is selected from the group consisting of: conductive carbon black, amine-group compound, phosphate compound, ethoxylated glycol esters of fatty acid, and fatty amine compound.
